(19) United States
(12) Patent Application Publication
(10) Pub. No.: US 2007/0180418 A1
(43) Pub. Date: Aug. 2, 2007

(54) Clock scheme for circuit arrangement

(76) Inventor: Fook Teng Fam, Penang (MY)

Correspondence Address: MOTOROLA, INC., 1303 EAST ALGONQUIN ROAD, IL01/3RD, SCHAUMBURG, IL, 60196, US

(21) Appl. No.: 11/343,018

(22) Filed: Jan. 30, 2006

(51) Int. Cl. G06F 17/50

(52) U.S. Cl. 716/8

(57) ABSTRACT

The present invention provides a circuit arrangement comprising a clock conductor (230-3) coupled to a number of circuit components (210-c, 210-d, 210-e), each said circuit component being coupled to the clock conductor with a respective filter (240-1, 240-2), wherein at least one of the filters is arranged to pass a clock signal having a first frequency and at least one of the other filters is arranged to pass a clock signal having a second frequency.

### FIELD OF THE INVENTION

The present invention relates generally to the provision of clock signals to various circuit components in a circuit arrangement; especially though not exclusively to printed circuit boards.

### BACKGROUND OF THE INVENTION

A concern in current printed circuit board (PCB) layout design is the challenge of packing circuit components in the ever shrinking PCB space in each new device platform, for example each new wireless electronics device such as a mobile phone or PDA. After the circuit components such as Integrated Circuits (IC) or chips are placed in a new layout, conductors or runners must be routed between the circuit components. As the number of conductors required increases in order to implement complex circuit arrangements, the challenge of routing these in a compact manner is exacerbated.

### SUMMARY OF THE INVENTION

In general terms in one aspect the present invention provides a common clock runner or conductor carrying two or more clock signals having different rates or frequencies. This common clock conductor is run or coupled to a number of circuit components on a PCB for example. Each circuit component is coupled to the clock conductor by respective filters which are arranged to pass the clock signal required by the circuit component. Thus although the clock conductor may carry two or more clock signals, each circuit component can reject all but the one (or more) clock signals it requires. By carrying all the clock signals on a common conductor or runner, the runner count for a PCB is reduced, allowing further miniaturization of the PCB, and reduced design costs.

In an embodiment two or more clock signals are coupled to the common clock conductor using an operational amplifier configured as an adder.

### BRIEF DESCRIPTION OF THE DRAWINGS

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram illustrating a known integrated circuit arrangement;

FIG. 2 is a schematic block diagram illustrating a circuit arrangement in accordance with an embodiment of the present invention;

FIG. 3 is a schematic diagram illustrating the combination of two clock signals on a single conductor in accordance with an embodiment of the present invention;

FIG. 4 is a schematic diagram illustrating the filtering of the two combined clock signals of FIG. 3 from a single conductor in accordance with an embodiment of the present invention; and

FIG. 5 is a circuit diagram illustrating a circuit for adding the clock signals of FIG. 3 in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus circuit components related to the activation and deactivation of a restricted service provider mode in an electronic device. Accordingly, the apparatus circuit components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. Also, throughout this specification the term “key” has the broad meaning of any key, button or actuator having a dedicated, variable or programmable function that is actuatable by a user.

It will be appreciated that embodiments of the invention described herein may be comprised of one or more conventional processors and unique stored program instructions that control the one or more processors to implement, in conjunction with certain non-processor circuits, some, most, or all of the functions of activation and deactivation of a restricted service provider mode in an electronic device described herein. The non-processor circuits may include, but are not limited to, a radio receiver, a radio transmitter, signal drivers, clock circuits, power source circuits, and user input devices. As such, these functions may be interpreted as steps of a method for activation and deactivation of a restricted service provider mode in an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

FIG. 1 illustrates a printed circuit board (PCB) layout 100 having a number of circuit components 110a-110e such as Integrated Circuits (IC) which are coupled together with a number of clock conductors or runners. Further non clock conductors are not shown for simplicity. Two clock sources or generators 120-1 and 120-2 are provided in two of the circuit components 110b and 110a respectively. The two clock sources 120-1 and 120-2 provide clock signals having different frequencies, CLK_1 and CLK_2 respectively. Typical clock signals for mobile phone devices include 32.768 KHz and 16.8 MHz. The runners or conductors associated with each clock signal 130-1 (CLK_1) and 130-2 (CLK_2) are coupled between the respective clock sources 120-1 and 120-2 and circuit components 110 requiring these clock signals as shown.

Typically the distances between the clock sources 120 and respective circuit components 110 vary up to the length of the PCB and beyond as the conductors are often forced to partially circumnavigate intermediate circuit components. Where circuit components 110e and 110d are at the opposite side of a PCB from the circuit components 110a and 110b associated with the clock sources 120, it can be seen that two long clock conductors 130-1 and 130-2 are required to service each of these distant circuit components 110e and 110d, which each require two clock signals. Thus four long conductors or runners 130 are required to support the clock signals as indicated by reference A. This duplication of long runners impedes the miniaturization of such PCBs, and increases the design burden.

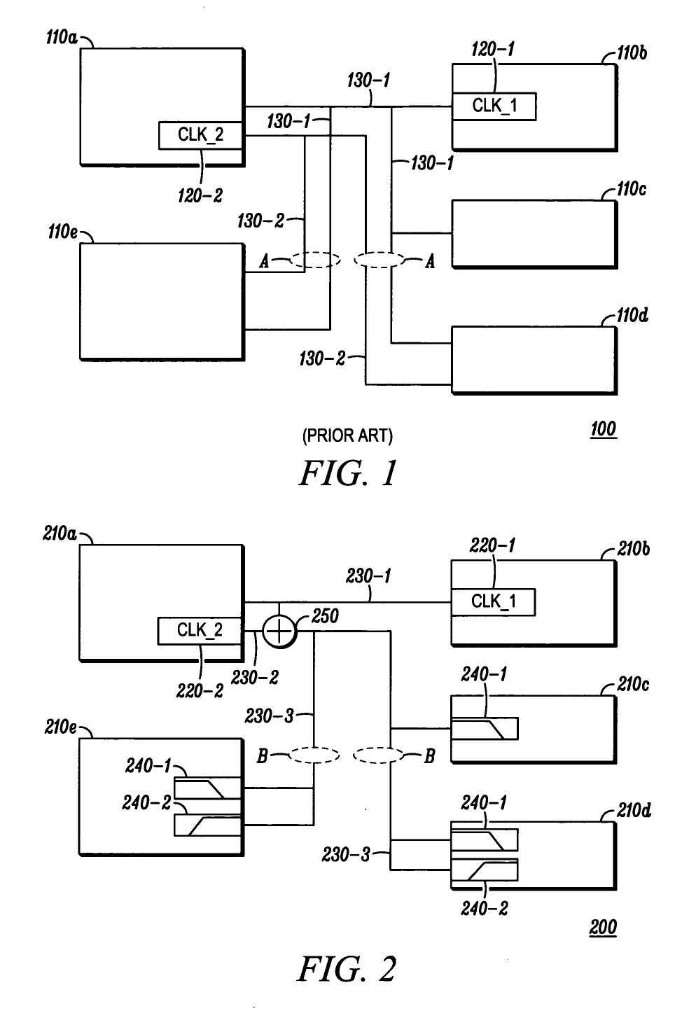

FIG. 2 illustrates a printed circuit board (PCB) layout 200 according to an embodiment of the present invention, and which has a number of circuit components 210a-210e corresponding to those of FIG. 1 and two clock sources or generators 220-1 and 220-2 are provided in two of the circuit components 210b and 210a respectively. As with the circuit arrangement of FIG. 1, the two clock sources 220-1 and 220-2 provide clock signals having different frequencies, CLK_1 and CLK_2 respectively. The runners or conductors associated with each clock signal 230-1 (CLK_1) and 230-2 (CLK_2) are coupled to their respective clock sources 220-1 and 220-2, and are also coupled via an adder 250 to a common clock conductor 220-3 which is also coupled to circuit components 110 requiring one or both of the clock signals (CLK_1 and CLK_2) as shown. Thus the common clock conductor 230-3 carries both the clock signals CLK_1 and CLK_2.

Each of the circuit components 210c, 210d, 210e coupled to the common clock conductor 230-3 comprise one or more filters 240-1 and 240-2 arranged to pass only one of the clock signals carried on the conductor 230-3. Thus there is provided a circuit arrangement comprising a clock conductor coupled to a number of circuit components, each said circuit component being coupled to the clock conductor with a respective filter, wherein at least one of the filters is arranged to pass a clock signal having a first frequency and at least one of the other filters is arranged to pass a clock signal having a second frequency.

As can be seen, in the situation examined above where circuit components 210e and 210d are a long distance from the clock sources 220, a reduced number of long runners or conductors (here indicated by reference B) are provided because the clock signals (CLK_1 and CLK_2) are carried on a single or common conductor 230-3. This reduction of long runners enables further miniaturization of the PCBs, and reduces the design burden.

Where a circuit component 210d or 210e requires both clock signals CLK_1 and CLK_2, though to different pins or sub-circuits, separate filters are used to recover each clock signal. Typically this can be implemented using high pass and low pass filters in order to recover the higher frequency (CLK_2) and the lower frequency (CLK_1) clock signals respectively. Where three or more clock signals are provided on a common clock conductor (230-3), band-pass filters may additionally be required to recover intermediate frequency clock signals. Where the clock frequencies are sufficiently different, for example 16.8 MHz and 32 KHZ, simple RC (resistor-capacitor) filters may be employed. However where the two (or more) clock frequencies are closer in frequency to each other, more complex filters may be required as would be appreciated by those skilled in the art.

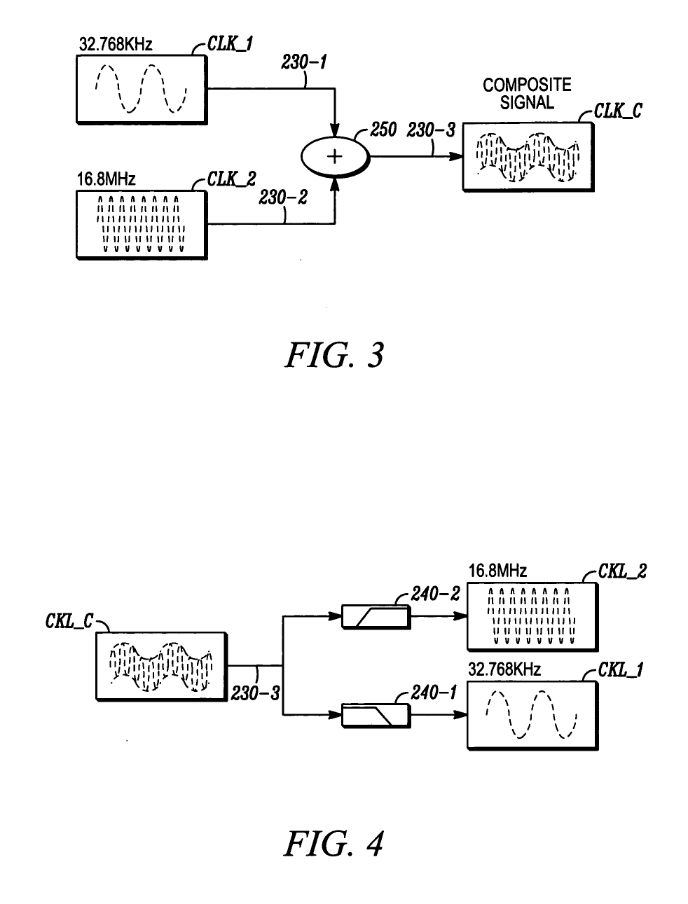

The combination of two clock signals CLK_1 and CLK_2 having different frequencies is illustrated in FIG. 3. Here the two clock signals are simply added together to generate a composite clock signal CLK_C from which the original clock signals can be recovered by simple filtering. However other mechanisms for combining and carrying the two (or more) clock signals can be used, for example frequency multiplication or modulation of a carrier wave. Similarly separating the two clock signals at different (or the same) circuit components 210 using different filters (240-1 and 240-2) is illustrated in FIG. 4. Here a high pass filter 240-2 passes a higher frequency clock signal CLK_2 and a low pass filter 240-1 passes a lower frequency clock signal CLK_1.

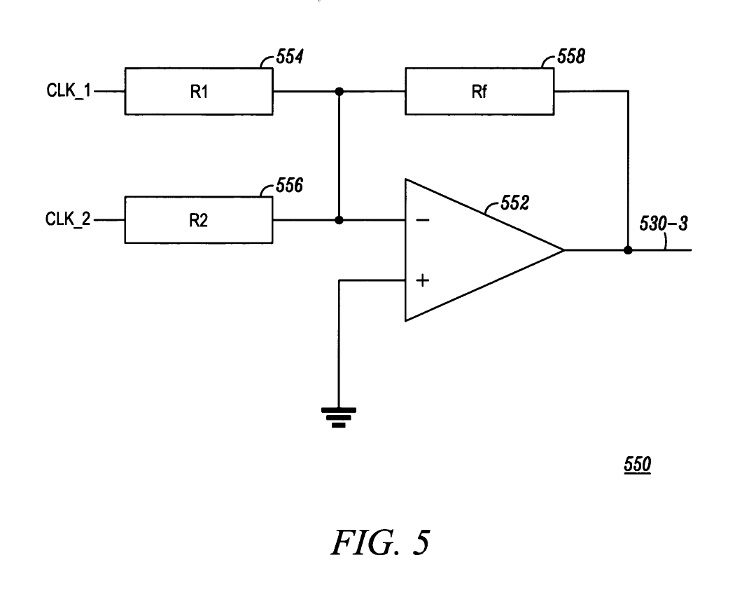

FIG. 5 illustrates a circuit 550 for adding two clock signals together and corresponds with the adder 250 shown in FIG. 2. The circuit 550 comprises an op amp 552 configured as an adder with two input resistors 554 (R1) and 556 (R2) coupled to the clock sources (220-1 and 220-1 respectively) for respective clock signals CLK_1 and CLK_2. A feedback resistor 558 (Rf) is provided as shown, and the values of the various resistors are chosen as is well known in order to provide the appropriate gain.

In an alternative arrangement, the two clock sources 220-1 and 220-2 may simply be coupled together using the same clock conductor, without recourse to a separate adding circuit (250). This will have the same effect of adding the two clock signals CLK_1 and CLK_2 together. In order to provide sufficient amplification for each clock signal and isolation between the combined signal and the separate clock sources, a buffer may be added to the output of each clock source 220. This arrangement is well suited to the situation in which the two clock sources 220-1 and 220-2 are distant from each other and would therefore require a long conductor or runner (eg 230-1) between one of the clock sources (220-1) and the adder 250. Where the two clock sources are close together on the PCB, an adder 250 can advantageously be used.

In addition to the reduction in conductor real estate on the PCB and the reduction in design effort, the common clock conductor also allows for reduced pin count on ICs or other circuit components which require multiple clock signals. This is because the common clock conductor can connect to a single clock pin, and the two or more clock signals can then be separated within the circuit component using internal filters. This further aids in the task of miniaturization.

In the foregoing specification, a specific embodiment of the present invention has been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A circuit arrangement comprising:
a clock conductor coupled to a number of circuit components, each said circuit component being coupled to the clock conductor with a respective filter, wherein at least one of the filters is arranged to pass a clock signal having a first frequency and at least one of the other filters is arranged to pass a clock signal having a second frequency.

2. A circuit arrangement as claimed in claim 1, further comprising:
a first clock source arranged to couple a clock signal having said first frequency onto the clock conductor;
a second clock source arranged to couple a clock signal having said second frequency onto the clock conductor.

3. A circuit arrangement as claimed in claim 2, wherein the first clock source and the second clock source are coupled to the clock conductor with an operational amplifier arranged as an adder.

4. A circuit arrangement as claimed in claim 1, wherein the circuit arrangement is implemented as a Printed Circuit Board and the clock conductor is implemented as a single runner on said Printer Circuit Board.

5. A method of operating a circuit arrangement having a number of circuit components and a clock conductor, the method comprising:
applying two clock signals to the clock conductor, the two clock signals having different frequencies;
filtering the clock signals to the circuit components in order to pass only one of said clock signals to respective circuit components.

6. A method of operating a circuit arrangement as claimed in claim 5, wherein the two applied clock signals are added together.
